(19) United States
(12) Patent Application Publication
(10) Pub. No.: US 2025/0249738 A1
(43) Pub. Date: Aug. 7, 2025

(54) Actuating Mechanism for Actuating a Loading, Tank or Service Cover of a Vehicle, in Particular in the Form of a Flap

(71) Applicant: Illinois Tool Works Inc., Glenview, IL (US)

(72) Inventor: Sebastian Öffner, Güntersleben (DE)

(21) Appl. No.: 19/011,275

(22) Filed: Jan. 6, 2025

(30) Foreign Application Priority Data
Feb. 6, 2024 (DE) 10 2024 103 247.2

(51) Int. Cl. B60K 15/05; B60L 53/16

(52) U.S. Cl. CPC B60K 15/05; B60L 53/16; B60K 2015/053; B60K 2015/0576

(57) ABSTRACT

The disclosure relates to an actuating mechanism (1) for actuating a charging, fueling, or service cover (2). The charging, fueling, or service cover (2) is reversibly movable between a closed position and an open position. The actuating mechanism (1) includes a drive for driving a drive shaft (4) and a drive mechanism associated with the drive, which is configured to tap a rotational movement of the drive shaft (4) when the drive is actuated and convert it into a first movement for manipulating a locking element (5) and into a second movement for moving, and in particular pivoting, the charging, fueling, or service cover (2). The drive mechanism associated with the drive includes a tie rod and/or push rod (6). The tie rod and/or push rod (6) are coupled to the locking element (5). The tie rod and/or push rod (6) are operatively connected to, or can be brought into operative connection with, the drive shaft (4) via a releasable engagement.

### RELATED APPLICATION

The present application claims the benefit of German Patent Application No. 10 2024 103 247.2, filed Feb. 6, 2024, titled “Actuating Mechanism for Actuating a Loading, Tank or Service Cover of a Vehicle, in Particular in the Form of a Flap,” the contents of which are hereby incorporated by reference.

### BACKGROUND

Vehicles with a hybrid or electromotive drive usually have one battery or traction battery, which, for example in the case of PHEV vehicles (PHEV=plug-in hybrid electric vehicle) or BEV vehicles (BEV=battery electric vehicle), can be charged via an electrical charging port that is accessible from the outside on the vehicle body, and is typically a charging port, by connecting to an electrical charging station, for example, or a conventional external electrical port.

The charging port is usually arranged in a charging well of the vehicle body, which is covered or closed by a charging flap or a charging closure element. A mechanism that cooperates with the charging flap or charging closure element selectively allows the charging well to be opened and closed or the charging flap or charging closure element to be flipped open and closed in relation to the charging well, and thus allows access to the charging port.

In vehicles with a combustion-based drive, a fuel tank is supplied with fuel via a refueling filler-neck, which is accessible from the outside by connection to a fuel pump or a refueling nozzle, for example. Corresponding to the charging port, the refueling nozzle is usually arranged in a refueling well assigned to the vehicle body, which is covered or closed by a refueling flap or a refueling closure element. Here, too, a mechanism that cooperates with the refueling flap or refueling closure element selectively allows the refueling well to be opened and closed or the refueling flap or refueling closure element to be flipped open and closed in relation to the refueling well, and thus allows access to the refueling filler-neck.

Actuating mechanisms and actuating apparatuses for opening and closing a cover in or on a vehicle are generally known from the prior art, for example from DE 10 2008 057 933 B4, DE 10 2009 060 119 A1, DE 10 2011 101 838 A1, and DE 10 2012 004 078 A1.

Despite advancements, however, there is a need for charging, fueling, or service compartment systems in which a plurality of functions must be switched and actuated in a coordinated manner.

### SUMMARY

The present disclosure relates generally to an actuating mechanism, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a side view, the exemplary embodiment of the actuating mechanism according to the disclosure, namely in a state in which the charging, fueling, or service flap is in its closed position and in which the locking element is in its locked position.

FIG. 2 illustrates schematically and in a side view, the exemplary embodiment of the actuating mechanism according to the disclosure according to FIG. 1, but in a state in which the locking element is in its unlocked position.

FIG. 3 illustrates schematically and in a side view, the exemplary embodiment of the actuating mechanism according to the disclosure according to FIG. 1, in a state in which, starting from the state shown in FIG. 2, the locking element is in its unlocked position and in which the charging, fueling, or service cover is transferred into its open position.

FIG. 4 illustrates schematically and in a side view, the exemplary embodiment of the actuating mechanism according to the disclosure, namely in a state in which, starting from the state shown in FIG. 3, the locking element is (again) in the locked position and in which the charging, fueling, or service cover is further moved towards the open position.

FIG. 5 illustrates schematically and in a side view, the exemplary embodiment of the actuating mechanism according to the disclosure, namely in a state in which, starting from the state shown in FIG. 4, the charging, fueling, or service cover is in its open position.

FIG. 6 illustrates schematically and in a side view, the exemplary embodiment of the actuating mechanism according to the disclosure, namely in a state in which, starting from the state shown in FIG. 5, the charging, fueling, or service cover is moved back towards the closed position.

FIG. 7 illustrates schematically and in a side view, the exemplary embodiment of the actuating mechanism according to the disclosure, namely in a state in which, starting from the state shown in FIG. 6, the charging, fueling, or service cover is moved towards the closed position far enough that a region of the charging, fueling, or service cover that is provided in particular on the inner side of the charging, fueling, or service cover strikes against the locking element which is in its locked position.

FIG. 8 illustrates schematically and in a side view, the exemplary embodiment of the actuating mechanism according to the disclosure, namely in a state in which, starting from the state shown in FIG. 7, the charging, fueling, or service cover is moved further towards the closed position, as a result of which the locking element is pushed from its locked position towards the unlocked position.

FIG. 9 illustrates schematically and in a side view, the exemplary embodiment of the actuating mechanism according to the disclosure, namely, in a state in which, starting from the state shown in FIG. 8, the charging, fueling, or service cover is moved further towards the closed position.

FIG. 10 illustrates schematically and in a side view, the exemplary embodiment of the actuating mechanism according to the disclosure, namely in a state in which, starting from the state shown in FIG. 9, the charging, fueling, or service cover is again in the closed position and the locking element is again in the locked position.

FIG. 11 illustrates schematically and in a side view, the exemplary embodiment of the actuating mechanism according to the disclosure in the state shown in FIG. 1 or in FIG. 10, together with an exemplary embodiment of an in particular manually actuatable emergency release.

FIG. 12 illustrates schematically and in a side view, the exemplary embodiment of the actuating mechanism according to FIG. 11, namely in a state after the emergency release has been actuated and the locking element is manually moved into its unlocked position.

FIG. 13 illustrates schematically and in a side view, the exemplary embodiment of the actuating mechanism according to the disclosure, namely in a state in which, starting from the state shown in FIG. 12, the emergency release is further manipulated so that a discharge element of the flap lock/restraint configured in particular as a protrusion has been transferred into its second in particular exposed position.

FIG. 14 illustrates schematically and in a side view, the exemplary embodiment of the actuating mechanism according to the disclosure, namely in a state in which, starting from the state shown in FIG. 13, the charging, fueling, or service cover is in particular moved manually towards the open position.

FIG. 15 illustrates schematically and in a side view, the exemplary embodiment of the actuating mechanism according to the disclosure, namely in a state in which, starting from the state shown in FIG. 14, the charging, fueling, or service cover is in particular manually pushed back into the closed position again, wherein a region on the inner side of the charging, fueling, or service cover strikes against the discharge element of the flap lock/restraint.

FIG. 16 illustrates schematically, and in a side view, the exemplary embodiment of the actuating mechanism according to the disclosure, namely in a state in which, starting from the state shown in FIG. 15, the charging, fueling, or service cover is manually moved (pushed) back into the closed position.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

As used herein, the terms “charging, fueling, or service flap” or “charging, fueling, or service cover” or “charging, fueling, or service compartment” are understood to mean not merely the components associated with a fuel tank or the components necessary for filling a fuel tank. Rather, these terms are also intended to include components for a tank for receiving other resources, for example AdBlue or urea, or an additive such as water. Accordingly, the disclosure also relates to actuating mechanisms for actuating service flaps associated with a filling system for a resource or additive fueling, in particular a fuel, AdBlue, or water tank.

Generally speaking, the disclosure relates to an actuating mechanism for actuating covers configured in particular as charging, fueling, or service flaps, in a charging, fueling, or service compartment which is or can be received on or in a body component of a vehicle. Furthermore, the disclosure relates to a corresponding system having a cover, in particular in the form of a charging, fueling, or service flap, and a charging, fueling, or service compartment, which is or can be received on or in a body component of a vehicle, wherein the cover (i.e. the charging, fueling, or service flap in particular) is reversibly movable between a closed position and an open position in relation to the charging, fueling, or service compartment and wherein a locking and/or restraint device is provided for locking a charging, fueling, or service flap. Finally, the disclosure further relates to a vehicle having such a system. The vehicle is in particular a vehicle having a hybrid or electromotive drive, wherein however vehicles having a purely combustion-based drive are not excluded in the context of the present disclosure.

A need exists for charging, fueling, or service compartment systems in which a plurality of functions must be switched and actuated in a coordinated manner. These functions include, in particular, the unlocking and locking or releasing and blocking of the cover or charging, fueling, or service flap with the aid of a flap lock, moving the unlocked charging, fueling, or service flap relative to the charging, fueling, or service compartment such that the charging, fueling, or service flap is transferable from a closed position into an open position (and vice versa), and other functions such as enabling or disabling a light source for illuminating at least one region of the charging, fueling, or service compartment in its open state.

The different functions or functional components of the charging, fueling, or service compartment system must be controlled or manipulated in coordination with respect to time. For example, during a charging operation, it is first necessary to unlock the charging, fueling, or service flap in its closed position with the aid of the flap lock of the charging, fueling, or service compartment system, wherein the charging, fueling, or service flap can be moved relative to the charging, fueling, or service compartment only after the unlocking of the charging, fueling, or service flap in order to transfer it into the open state. Only then can the charging port or charging connector be connected and thereafter locked.

In order to manipulate and coordinate these functions or functional components, it is common to associate multiple actuators with the charging, fueling, or service compartment system, wherein each actuator takes over the actuation of a correspondingly associated functional component, such as triggering the flap lock and moving the unlocked charging, fueling, or service flap relative to the charging, fueling, or service compartment. In order to coordinate the actuation of the various functional components of the charging, fueling, or service compartment system, a control device is typically used, which triggers the respective actuators in a coordinated manner.

On the other hand, such charging, fueling, or service compartment systems, particularly during charging, are subjected to a variety of weather conditions, which can lead to sealing problems due to the functional components mentioned above. Individual components such as the charging, fueling, or service flap, can also become iced.

Accordingly, the underlying problem of the disclosure is in particular to further develop a locking and/or restraint device for charging, fueling, or service flaps in such a way that it has a relatively small construction space requirement, wherein preferably at the same time several functions or functional components of the charging or fueling compartment system can be controlled in a reliable and coordinated manner.

In addition, or alternatively, according to at least one sub-problem addressed by the disclosure, the aim is for the locking and/or locking device to also remain usable when the charging, fueling, or service flap is iced.

Furthermore, according to at least one sub-problem addressed by the disclosure, it is desirable to provide an emergency release for a charging, fueling, or service compartment system.

Accordingly, the disclosure relates in particular to an actuating mechanism for actuating a charging, fueling, or service cover configured in particular as a flap on a charging, fueling, or service compartment that is or can be received on or in a body component of a vehicle, wherein the charging, fueling, or service cover is reversibly movable, and in particular pivotable, between a closed position and an open position in relation to the charging, fueling, or service compartment.

The actuating mechanism according to the disclosure comprises a drive, in particular in the form of an electric motor, for driving a drive shaft and a drive mechanism associated with the drive, which is configured to tap a rotational movement of the drive shaft when the drive is actuated and convert it into a first movement for manipulating a locking element of a flap lock/restraint and into a second movement for moving, and in particular pivoting, the charging, fueling, or service cover.

According to at least one aspect of the disclosure, it is provided in particular that the locking element is movable between a locked position and an unlocked position relative to the charging, fueling, or service compartment, and in particular is pivotably supported about an axis of rotation. The locking element can in particular be mounted in a linearly movable manner between a locked position and an unlocked position relative to the charging, fueling, or service compartment.

To manipulate the locking element as needed, the drive mechanism associated with the drive comprises a tie element and/or push element, in particular a tie rod and/or push rod, wherein the tie element and/or push element or the tie rod and/or push rod, is coupled to the locking element, in particular via an end region of the tie rod and/or push rod facing the locking element.

Furthermore, it is provided in particular that the tie rod and/or push rod is operatively connected to, or can be brought into operative connection with, the drive shaft via a releasable engagement.

The actuating mechanism can control a plurality of functions of the charging, fueling, or service cover. Thus, with a single drive, the movement of the charging, fueling, or service cover relative to the charging, fueling, or service compartment on the one hand, as well as a manipulation of the flap lock/restraint on the other hand, can be achieved.

Still more functional elements can also be activated or deactivated via the same actuating mechanism.

According to implementations of the actuating mechanism according to the disclosure, it is provided that the drive mechanism associated with the drive comprises a protrusion operatively connected to the drive shaft and serving as a tappet element, which is or can be brought into a releasable engagement with a protruding region of the tie rod and/or push rod, so that, when the drive shaft is rotated in a first direction of rotation and about a first rotational angular range, the protrusion of the drive shaft serving as the tappet element pulls the tie rod and/or push rod in a direction away from the locking element, at least by a predefined or definable distance.

In this context, it is contemplated in particular that that the predefined or definable distance, by which the tie rod and/or push rod is or can be moved upon a rotation of the drive shaft in the first direction of rotation and about the first rotational angular range with the protrusion of the drive shaft serving as the tappet element, is selected such that, during the movement of the tic rod or and/or push rod by the predefined or definable distance, the locking clement is moved, and in particular pivoted, from its locked position into its unlocked position.

According to further developments of the last mentioned design variants of the actuating mechanism according to the disclosure, it is provided that the protrusion of the drive shaft serving as the tappet clement is configured such that, when the drive shaft is further rotated beyond the first rotational angular range, the engagement between the protrusion of the drive shaft serving as the tappet element and the protruding region of the tie rod and/or push rod is released.

In such a situation, the operative connection between the tie rod and/or push rod and the drive shaft of the drive is then interrupted, so that, in the event of a further rotation of the drive shaft, this then has no influence on a manipulation of the locking element of the flap lock/restraint.

According to implementations of the actuating mechanism according to the disclosure, it is provided that the releasable engagement between the protrusion of the drive shaft serving as the tappet clement and the protruding region of the tie rod and/or push rod is selected such that, even without a rotation of the drive shaft in the first direction of rotation, the tie rod and/or push rod can be moved in the direction away from the locking element or in the direction towards the locking element, in particular in a situation in which the locking element is moved, and in particular pivoted, from its locked position into its unlocked position via a preferably manually actuatable emergency release.

This is particularly true in a situation in which the locking element is moved, and in particular pivoted, from its locked position into its unlocked position via a preferably manually actuatable emergency release.

To implement such a decoupling, it is provided according to embodiments of the disclosure that the protrusion of the drive shaft serving as the tappet element and/or the protruding region of the tie rod and/or push rod is configured flexibly and in particular elastically in such a way that, even without a rotation of the drive shaft in the first direction of rotation, the tie rod and/or push rod can be moved in the direction away from the locking element or in the direction towards the locking element, in particular in a situation in which the locking element is moved, and in particular pivoted, from its locked position into its unlocked position via a preferably manually actuatable emergency release.

In this way, it is ensured that the locking element is movable, and in particular pivotable, when the emergency release is actuated and is not blocked by the drive and/or by the drive mechanism associated with the drive.

In particular, the locking element is associated with a biasing element that biases the locking element into its locked position. The biasing element is in particular a spring, preferably a leg spring, which is arranged coaxially or concentrically to the rotary shaft of the locking element. Of course, other embodiments for the biasing element can also be considered here.

In particular, according to one aspect of the disclosure, for the as-needed decoupling, i.e. for releasing the engagement between the protrusion of the drive shaft serving as the tappet clement and the tie rod and/or push rod or the protruding region of the tie rod and/or push rod as needed, the tie rod and/or push rod is at least regionally flexible or spring-elastic, or comprises a flexibly or spring-elastically configured region, such that the charging, fueling, or service cover is manually transferable from its open position into its closed position and, in doing so, the locking clement is manually transferable from its spring-biased locked position into its unlocked position.

With this measure, it is also possible, even without the drive, for example manually, to transfer the charging, fueling, or service cover from its open position into its closed position without the drive mechanism associated with the drive blocking such a movement.

In particular, the locking element is configured to engage in its locked position with a locking element of the charging, fueling, or service cover when, and in particular only when, the charging, fueling, or service cover is in its closed position.

According to embodiments of the actuating mechanism according to the disclosure, the tie rod and/or push rod is associated with a bearing, in particular in the form of a radial sliding bearing, in order to guide a movement of the tie rod and/or push rod relative to the charging, fueling, or service compartment accordingly.

Preferably, in the actuating mechanism according to the disclosure, it is provided that the flap lock/restraint comprises a discharge element, which is configured in particular as a protrusion and which, together with the locking element, is mounted to be pivotable about the axis of rotation of the locking element relative to the charging, fueling, or service compartment between an in particular countersunk first position and an in particular exposed second position.

The discharge element is in its first in particular countersunk position when the locking clement is in its locked position, wherein the discharge element is transferred into its second in particular exposed position when the locking element is transferred into its unlocked position. The discharge element is configured such that, when the discharge element is transferred into its second in particular exposed position, the discharge element strikes against a region of the charging, fueling, or service cover provided in particular on an inner side of the charging, fueling, or service cover and in doing so moves the latter from its closed position towards its open position.

The discharge element exercises in particular a break-up function (e.g., ice breaking function). In so doing, the discharge element can push the charging, fueling, or service cover out of its closed position if it is jammed or otherwise blocked even after the unlocking, i.e., when the locking element has been moved into its unlocked position. This can occur, for example, due to icing in winter. However, dirt or other fault origins can also cause the charging, fueling, or service cover to jam. The discharge element can thus forcibly push open the charging, fueling, or service cover.

Due to the fact that the discharge element is pivotally mounted along with the locking element about the axis of rotation of the locking element relative to the charging, fueling, or service compartment, a synchronization between the locking element on the one hand and the discharge element on the other hand occurs. In other words, when the drive shaft is moved in the first direction of rotation and about the first rotational angular range, the locking element is first transferred into its unlocked position. Then, or during the transfer of the locking element into its unlocked position, the discharge element comes into contact with the region provided in particular on the inner side of the charging, fueling, or service cover, as a result of which a corresponding discharge pulse is applied to the charging, fueling, or service cover.

With regard to the drive mechanism associated with the drive, according to design variants of the actuating mechanism according to the disclosure, it is provided that the drive mechanism associated with the drive comprises a drive wheel operatively connected to the drive shaft, which is provided at least partially or regionally as a drive gearwheel having a toothing, in particular a front toothing.

For moving and in particular pivoting the charging, fueling, or service cover relative to the charging, fueling, or service compartment, the charging, fueling, or service cover is associated with a corresponding pivoting mechanism, which comprises a shaft extending along a pivot axis of the charging, fueling, or service cover with a drive wheel operatively connected thereto. The drive gear is preferably at least partially or regionally provided as a gearwheel having a toothing, in particular a front toothing, wherein, in the case of a transfer of the charging, fueling, or service cover from its closed position into its open position (and vice versa) caused by means of the drive, the toothing of the drive gearwheel, which is configured in particular as a front toothing, is engaged (in a meshing manner) with the toothing of the drive wheel, which is configured in particular as a front toothing, of the pivoting mechanism associated with the charging, fueling, or service cover.

In this context, it is expedient that the drive gearwheel, and in particular the toothing of the drive gearwheel, which is configured in particular as a front toothing, and the drive wheel of the pivoting mechanism associated with the charging, fueling, or service cover, and in particular the toothing of the drive wheel of the pivoting mechanism associated with the charging, fueling, or service cover, which is configured in particular as a front toothing, are configured to engage with one another only when the protrusion of the drive shaft serving as the tappet element is rotated about the first rotational angular range.

Due to this easy-to-implement yet effective drive mechanism, it is ensured that, in a synchronized manner, the charging, fueling, or service cover is moved from its closed position into its open position by way of the correspondingly associated pivoting mechanism, namely after the locking element has previously been transferred into its unlocked position, and after the discharge element has forcibly pushed open the charging, fueling, or service cover towards the open position.

According to design variants of the drive mechanism associated with the drive, it is provided that the drive gear, and in particular the toothing of the drive gear configured in particular as a front toothing and the drive gear of the pivoting mechanism associated with the charging, fueling, or service cover, and in particular the toothing of the drive wheel of the pivoting mechanism associated with the charging, are configured such that, in the closed position of the charging, fueling, or service cover, a rotation of the drive wheel of the pivoting mechanism associated with the charging, fueling, or service cover is not blocked.

In particular, a rotation of the drive wheel of the pivoting mechanism associated with the charging, fueling, or service cover is not blocked by the drive gearwheel, so that, even without an activation of the drive, the charging, fueling, or service cover is in particular manually transferable from its closed position into its open position, in particular in a situation after the locking element has been moved, and in particular pivoted, from its locked position into its unlocked position via a manually actuatable emergency release.

According to preferred implementations of the flap lock/restraint, it is provided that the flap lock/restraint comprises a rotary body, which is mounted pivotably about the axis of rotation of the locking element relative to the charging, fueling, or service compartment, having a first lever arm region, which forms the locking element, a second lever arm region, which forms the discharge clement, and a third lever arm region, to which the end region of the tie rod and/or push rod facing the locking element is connected in an articulated manner.

In this context, it is expedient that the rotary body of the flap lock/restraint further comprises a fourth lever arm region, to which a tie element and/or push element of an in particular manually actuatable emergency release is connected in an articulated manner in such a way that, upon actuation of the emergency release, the rotary body with its lever arm regions is rotatable about the axis of rotation of the locking element.

In order for the tie element and/or push element of the in particular manually actuatable emergency release to remain stationary at least for this long relative to the charging, fueling, or service compartment, it is provided according to further developments of the last mentioned design variant of the actuating mechanism according to the disclosure that the tie element and/or push element of the in particular manually actuatable emergency release comprises a freewheel, which is configured such that a rotation of the rotary body of the flap lock/restraint about the axis of rotation of the locking element is possible without introducing a force component into the tic clement and/or push element of the emergency release via the fourth lever arm region of the rotary body, which would cause a movement of the tie element of the emergency release relative to the rotary body of the flap lock/restraint.

Various embodiments are considered for the implementation of such a freewheel. It is contemplated, for example, that the freewheel comprises an elongated hole guide, which is configured in particular in the tie element and/or push element of the emergency release, into which a pin element or sliding block of the fourth lever arm region engages.

In this context, it is contemplated that, by pulling the tie element of the emergency release, the tie element and/or push element is movable relative to the rotary body of the flap lock/restraint by a distance defined by the elongated hole guide configured in particular in the tic clement and/or push element of the emergency release without a force component, in particular a tensile force component, being introduced from the tie element and/or push element of the emergency release into the rotary body of the flap lock/restraint.

In particular, it is preferably provided in this case that, after overcoming the distance defined by the elongated hole guide configured in particular in the tie element and/or push element of the emergency release, a tensile force component introduced into the tie element and/or push element of the emergency release is introduced in particular directly into the rotary body of the flap lock/restraint, and in doing so the torque necessary for the rotation of the rotary body is produced.

Preferably, a restraint can be associated with the tie element and/or push element of the emergency release for restraining the tie element and/or push element in a position of the tie element after the distance defined by the elongated hole guide configured in particular in the tie element and/or push element of the emergency release has been overcome.

With this measure, it is ensured that the tie element and/or push element is stationary relative to the charging, fueling, or service compartment, even after activation of the emergency release.

In the accompanying drawings, an exemplary embodiment of the actuating mechanism 1 according to the disclosure is shown in different positions/situations in order to illustrate the construction and functionality of the actuating mechanism 1.

Generally speaking, the actuating mechanism 1 serves to actuate a charging, fueling, or service cover 2 configured in particular as a flap on a charging, fueling, or service compartment 3 that is or can be received on or in a body component of a vehicle.

The charging, fueling, or service cover 2 can be reversibly moved, and in particular pivoted, between a closed position and an open position relative to the charging, fueling, or service compartment 3, in particular in an electromotive manner and, in an emergency, in particular manually with the aid of an emergency release.

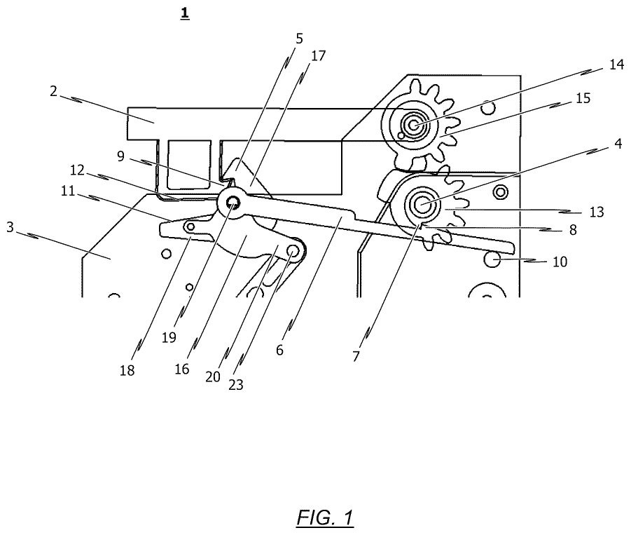

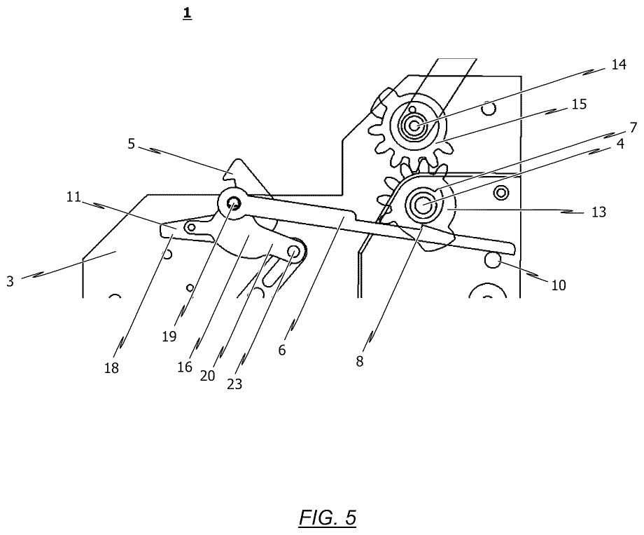

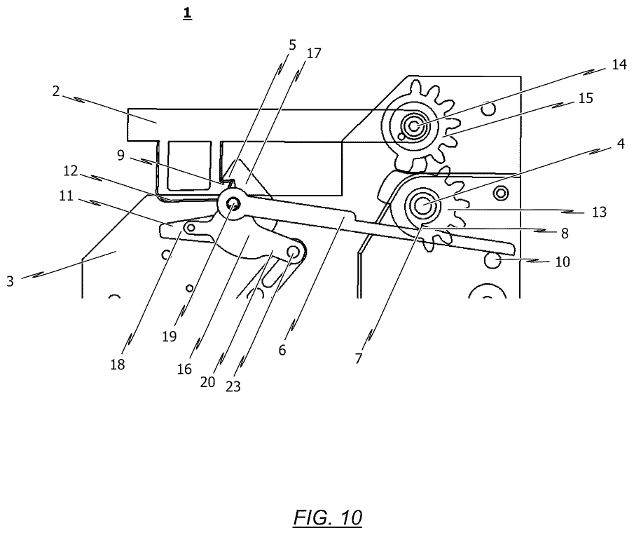

In FIG. 1 and FIG. 10, the charging, fueling, or service cover 2 is shown in its closed position, while for example FIG. 5 shows the charging, fueling, or service cover 2 in its open position.

To move/pivot the charging, fueling, or service cover 2 in a motorized manner, the actuating mechanism 1 comprises a drive, in particular in the form of an electric motor. The drive serves to drive a corresponding drive shaft 4.

In order to tap corresponding movements of the drive shaft 4 driven by the drive and use them for manipulating different components of the actuating mechanism 1, the actuating mechanism 1 comprises a drive mechanism correspondingly associated with the drive and configured to tap a rotational movement of the drive shaft 4 when the drive is actuated and convert it into a first movement for manipulating a locking element 5 of a flap lock/restraint and into a second movement for moving, and in particular pivoting, the charging, fueling, or service cover 2. In particular, the drive mechanism associated with the drive is configured to temporally coordinate the first and second movement, namely such initially that first movement and subsequently the second movement are brought about.

As illustrated in the drawings, the drive mechanism associated with the drive comprises a drive wheel operatively connected to the drive shaft 4, being at least partially or regionally configured as a drive gearwheel 13 having a front toothing.

For moving and in particular pivoting the charging, fueling, or service cover 2 relative to the charging, fueling, or service compartment 3, the charging, fueling, or service cover 2 is associated with a corresponding pivoting mechanism, which comprises a shaft extending along a pivot axis 14 of the charging, fueling, or service cover 2 with a drive wheel 15 operatively connected thereto. The drive wheel 15 is also at least partially or regionally configured as a gearwheel with a front toothing.

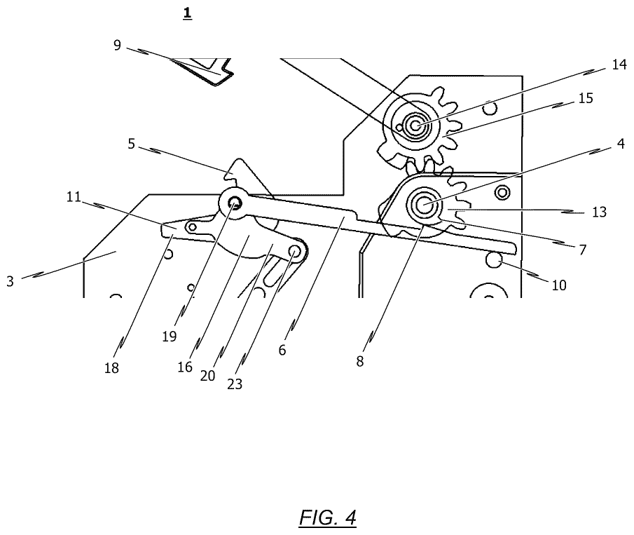

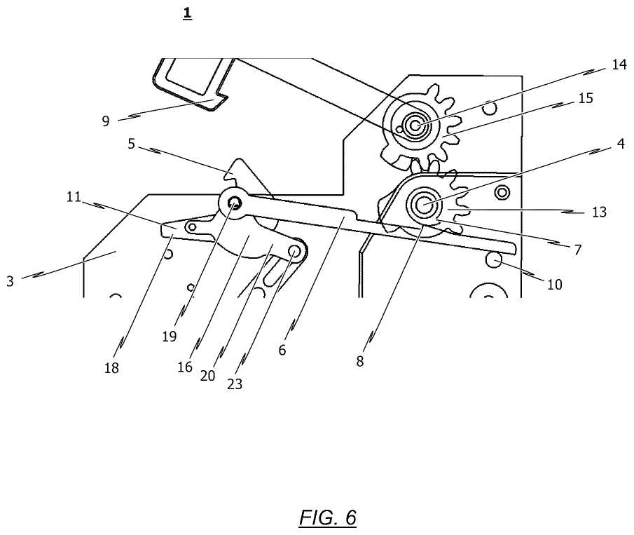

As shown for example in FIG. 4, FIG. 5, and FIG. 6, the toothing of drive gearwheel 13 configured as a front toothing is engaged with the front toothing of drive gear 15 of the pivoting mechanism associated with charging, fueling, or service cover 2 when, with the aid of the drive, the charging, fueling, or service cover 2 is transferred from its closed position into its open position, and vice versa.

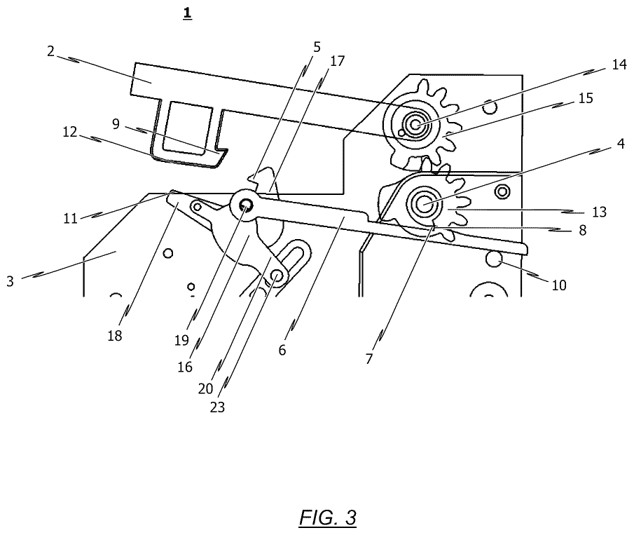

The locking element 5 of the flap lock/restraint of the actuating mechanism 1 itself is pivotally mounted between a locked position (cf. for example FIG. 1) and an unlocked position (cf. for example FIG. 3) about an axis of rotation relative to the charging, fueling, or service compartment 3.

Although not shown in the drawings, a biasing element, for example in the form of a spring, is in particular associated with the locking element 5 and biases the locking element 5 into its locked position (cf. for example FIG. 1).

To manipulate the locking element 5 as needed, and in particular to transfer the locking element 5 from the biased locked position into the unlocked position, the drive mechanism associated with the drive of the actuating mechanism 1 comprises a tie rod and/or push rod 6. As shown in the drawings, the tie rod and/or push rod 6 are coupled to the locking element 5 via an end region of the tie rod and/or push rod 6 facing the locking element 5.

On the other hand, the tie rod and/or push rod 6 is operatively connected to the drive shaft 4 and/or can be brought into operative connection with the drive shaft 4 via a releasable engagement.

For this purpose in particular, the drive mechanism associated with the drive comprises a protrusion operatively connected to the drive shaft 4 and serving as a tappet element 7, which is or can be brought into a releasable engagement with a protruding region 8 of the tie rod and/or push rod 6, so that, when the drive shaft 4 is rotated in a first direction of rotation and about a first rotational angular range, the protrusion of the drive shaft 4 serving as the tappet element 7 pulls the tie rod and/or push rod 6 in a direction away from the locking element 5, at least by a predefined or definable distance.

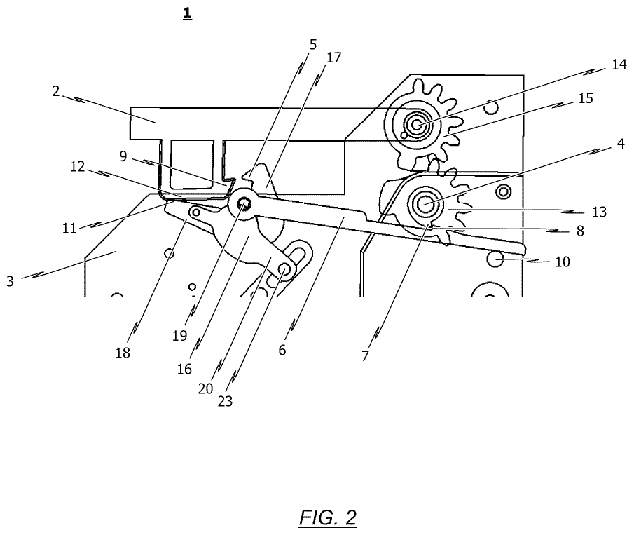

In FIG. 1 to FIG. 3, a respective state is shown in which the protrusion of the drive shaft 4 serving as the tappet element 7 is engaged with the protruding region 8 of the tie rod and/or push rod 6. It can be seen that, when the drive shaft 4 is rotated (in this case: counter-clockwise), the tie rod and/or push rod 6 is also moved due to the engagement and thus is pulled in a direction away from the locking element 5.

The predefined distance, by which the tie rod and/or push rod 6 is moved upon a rotation of the drive shaft 4 in the first direction of rotation and about the first rotational angular range with the protrusion of the drive shaft 4 serving as the tappet element 7, is selected such that the locking element 5 is moved, and in particular pivoted, from its locked position (cf. FIG. 1) into its unlocked position (FIG. 3).

The illustration in FIG. 4 shows that the protrusion of the drive shaft 4 serving as the tappet element 7 is configured such that, when the drive shaft 4 is further rotated beyond the first rotational angular range, the engagement between the protrusion of the drive shaft 4 serving as the tappet element 7 and the protruding region 8 of the tie rod and/or push rod 6 is released.

Due to the fact that the tie rod and/or push rod 6 is no longer in operative connection with the drive shaft 4, the locking element 5 moves back into its locked position due to the biasing element (spring) associated with the locking element 5 (cf. FIG. 4).

In the situation shown in FIG. 4, it can also be seen that the toothing of the drive gearwheel 13, configured here as a front toothing, engages with the toothing of the drive wheel 15 of the pivoting mechanism associated with the charging, fueling, or service cover 2, also configured here as a front toothing.

When the drive shaft 4 rotates further (cf. FIG. 5) a rotary torque is exerted on the charging, fueling, or service cover 2 via the drive shaft 4 due to the meshing toothing of the drive gearwheel 13 and the drive gear 15 of the pivoting mechanism associated with the charging, fueling, and service cover 2, such that the latter is pivoted into the open position shown in FIG. 5.

In order to transfer the charging, fueling, or service cover 2 from the open position shown for example in FIG. 5 back into its closed position with the aid of the drive, the direction of rotation of the drive is changed, and a corresponding rotary torque is transferred via the meshing toothing formed between the drive gearwheel 13 and the drive wheel 15 of the pivoting mechanism associated with the charging, fueling, or service cover 2.

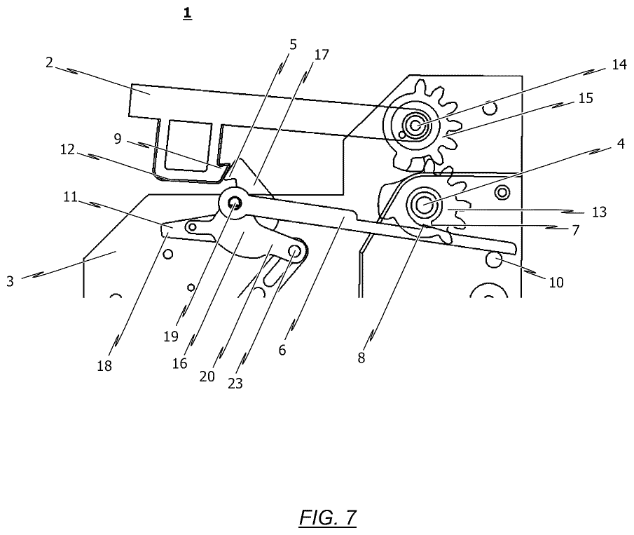

Shortly before reaching the closed position of the charging, fueling, or service cover 2, the protrusion of the drive shaft 4 serving as the tappet element 7 comes back into contact with the tie rod and/or push rod 6, as shown in FIG. 7.

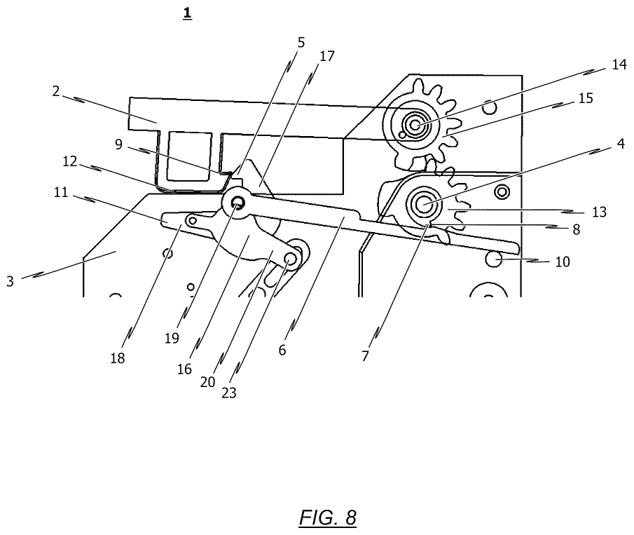

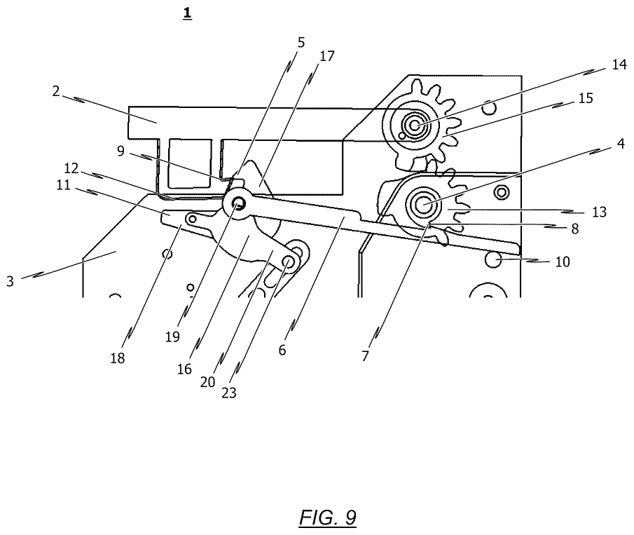

Here, the tie rod and/or push rod 6 is at least regionally flexible or spring-elastic, or comprises a flexibly or spring-elastically configured region, such that the protrusion serving as the tappet element 7 can slide over the protruding region 8 of the tie rod and/or push rod 6 to again be in a releasable engagement with the protruding region 8 of the tie rod and/or push rod 6, as shown in FIG. 7 to FIG. 10.

In the movement sequence shown in FIG. 7 to FIG. 10, region 12 of the charging, fueling, or service cover 2 provided on an inner side of the charging, fueling, or service cover 2 strikes against the locking element 5 and moves it at least partially out of the locked position of the locking element 5 counter to the biasing force of the biasing element associated with the locking element 5 until the locking element 5 can snap back and enter into engagement with a locking element 5 of the charging, fueling, or service cover 2.

In particular, it is provided that the locking element 5 of the flap lock/restraint is configured to engage in its locked position with a locking element 9 of the charging, fueling, or service cover 2 when, and in particular only when, the charging, fueling, or service cover 2 is in its closed position.

It can further be seen in the drawings that the flap lock/restraint comprises a discharge element 11 configured as a protrusion, which, together with the locking element 5 of the flap lock/restraint, is mounted pivotably about the axis of rotation of the locking element 5 relative to the charging, fueling, or service compartment 3 between a countersunk first position (cf. for example FIG. 1) and an exposed second position (cf. for example FIG. 3).

Specifically, the discharge element 11 is in its first (countersunk) position when the locking element 5 is in its locked position, wherein the discharge element 11 is transferred into its second (exposed) position when the locking element 5 is transferred into its unlocked position.

The discharge element 11 is preferably configured such that, when the discharge element 11 is transferred into its second (exposed) position, the discharge element 11 strikes against a region 12 of the charging, fueling, or service cover 2 provided on the inner side of the charging, fueling, or service cover 2 and in doing so moves/pushes the latter from its closed position towards its open position.

As also shown in the drawings, in the exemplary embodiment of the actuating mechanism 1 according to the disclosure, the tie rod and/or push rod 6 is associated with a bearing 10, in particular in the form of a radial sliding bearing, in order to guide a movement of the tie rod and/or push rod 6 relative to the charging, fueling, or service compartment 3.

In the exemplary embodiment of the actuating mechanism 1 according to the disclosure as shown in the drawings, it is provided in particular that the flap lock/restraint comprises a rotary body 16, which is mounted pivotably about the axis of rotation of the locking element 5 relative to the charging, fueling, or service compartment 3, having a first lever arm region 17, which at least partially or regionally forms the locking element 5, a second lever arm region 18, which at least partially or regionally forms the discharge element 11, and a third lever arm region 19, to which the end region of the tie rod and/or push rod 6 facing the locking element 5 is connected in an articulated manner. These three lever arm regions 17, 18, 19 are rotatable with one another about a common axis of rotation.

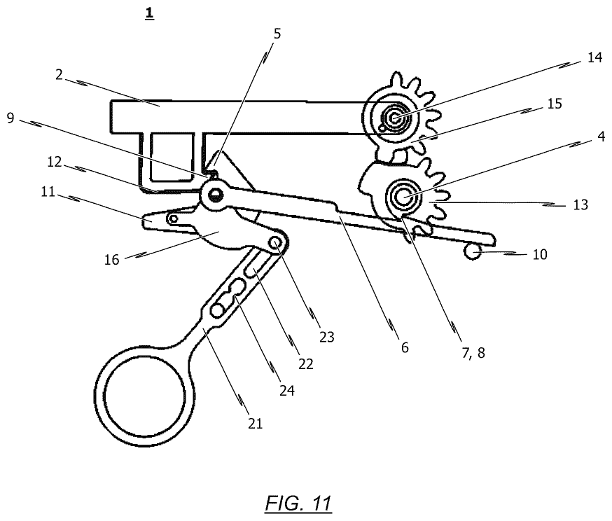

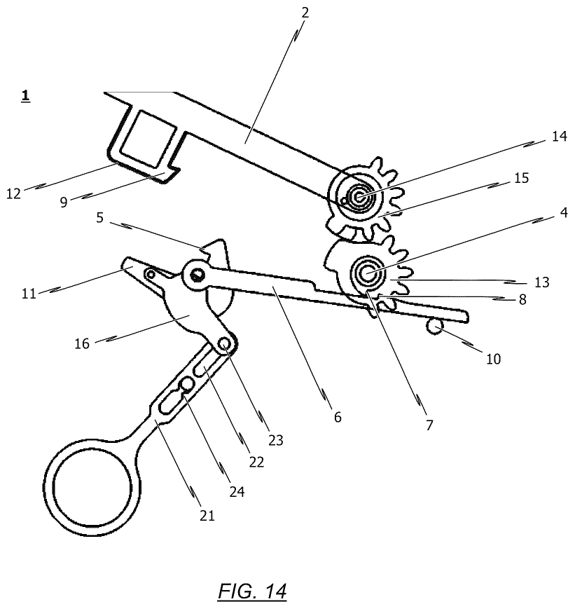

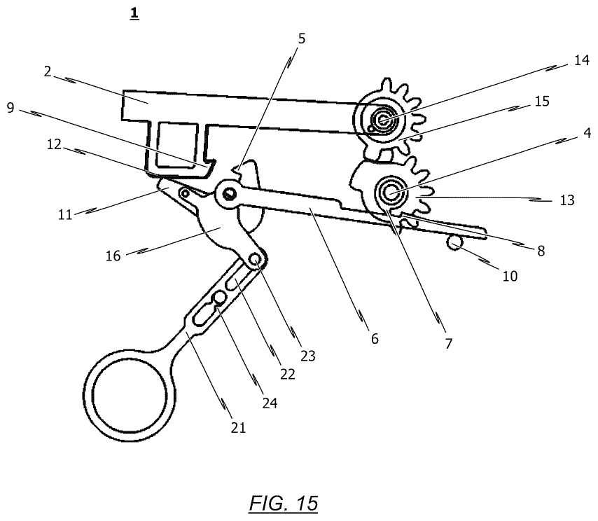

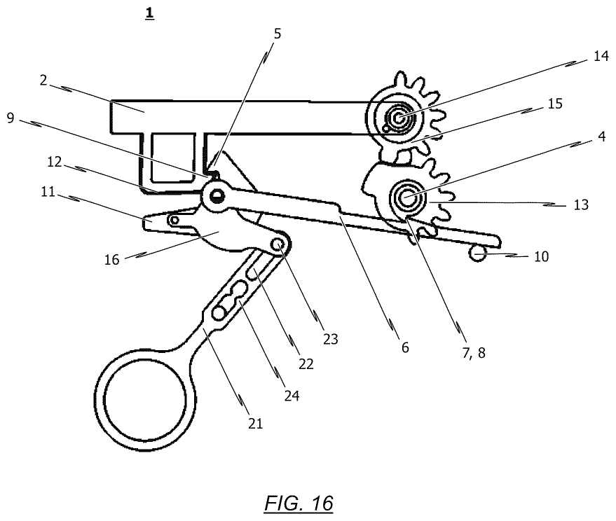

It can further be seen from the view in FIG. 11 to FIG. 16 that the rotary body 16 of the flap lock/restraint further comprises a fourth lever arm region 20, to which a tie element and/or push element 21 of an in particular manually actuatable emergency release is connected in an articulated manner in such a way that, upon actuation of the emergency release, the rotary body 16 with its lever arm regions 17, 18, 19, 20 is rotatable about the axis of rotation of the locking element 5.

In particular, it is provided that the tie element and/or push element 21 of the manually actuatable emergency release comprises a freewheel 22.

The freewheel 22 is configured in particular such that a rotation of the rotary body 16 of the flap lock/restraint about the axis of rotation of the locking element 5 is possible without introducing a force component into the tie element and/or push element 21 of the emergency release via the fourth lever arm region 20 of the rotary body 16, which would cause a movement of the tie element 21 of the emergency release relative to the rotary body 16 of the flap lock/restraint.

As can be seen from the illustrations in FIG. 11 to FIG. 16, the freewheel 22 comprises an elongated hole guide configured in the pull element and/or push element 21 of the emergency release, into which a pin element 23 or sliding block of the fourth lever arm region 20 engages.

By pulling the tie element 21 of the emergency release, the tie element and/or push element 21 is movable relative to the rotary body 16 of the flap lock/restraint by a distance defined by the elongated hole guide configured in the tie element and/or push element 21 of the emergency release without a force component, in particular a tensile force component, being introduced from the tie element and/or push element 21 of the emergency release into the rotary body 16 of the flap lock/restraint.

By contrast, after overcoming the distance defined by the elongated hole guide configured in the tie element and/or push element 21 of the emergency release, a tensile force component introduced into the tie element and/or push element 21 of the emergency release is introduced in particular directly into the rotary body 16 of the flap lock/restraint.

A restraint 24 is further associated with the tie element and/or push element 21 of the emergency release for releasably restraining the tie element 21 in a position of the tie element 21 after the distance defined by the elongated hole guide configured in particular in the tie element and/or push clement 21 of the emergency release has been overcome.

When considering the illustrations in FIG. 11 through FIG. 16 together, it can be seen that the drive gearwheel 13, and in particular the toothing of the drive gearwheel 13, which is configured as a front toothing, and the drive wheel 15 of the pivoting mechanism associated with the charging, fueling, or service cover 2, and in particular the toothing of the drive wheel 15 of the pivoting mechanism associated with the charging, fueling, or service cover 2, which is configured as a front toothing, are configured such that, in the closed position of the charging, fueling, or service cover 2, a rotation of the drive wheel 15 of the pivoting mechanism associated with the charging, fueling, or service cover 2 is not blocked, in particular not by the drive gearwheel 13, so that, even without activation of the drive, the charging, fueling, or service cover 2 is in particular manually transferable from its closed position into its open position, in particular in a situation after the locking element 5 has been moved, and in particular pivoted, from its locked position into its unlocked position via a preferably manually actuatable emergency release.

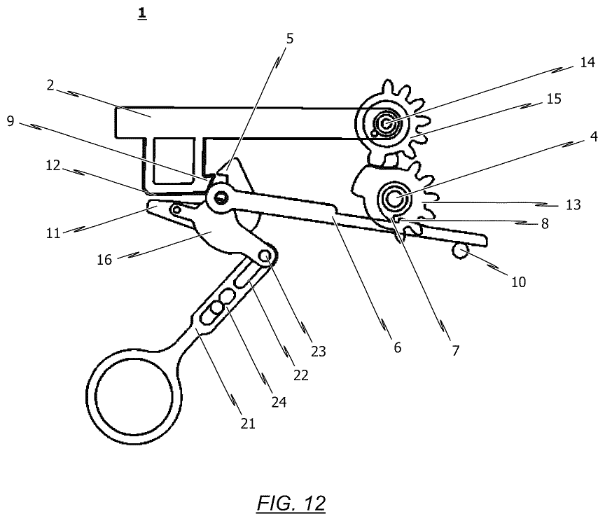

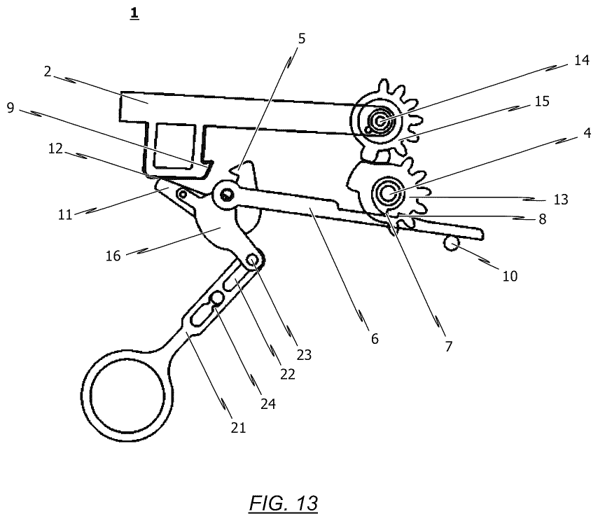

It can further be seen that the releasable engagement between the protrusion of the drive shaft 4 serving as the tappet clement 7 and the protruding region 8 of the tie rod and/or push rod 6 is selected such that, even without a rotation of the drive shaft 4 in the first direction of rotation, the tie rod and/or push rod 6 can be moved in the direction away from the locking element 5, in particular in a situation in which the locking element 5 is moved, and in particular pivoted, from its locked position into its unlocked position via the manually actuatable emergency release (cf. FIG. 12 and FIG. 13).

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Actuating mechanism
2 Charging, fueling, or service cover
3 Charging, fueling, or service compartment
4 Drive shaft
5 Locking element of a flap lock/restraint
6 Tie rod and/or push rod
7 Protrusion of the drive shaft serving as the tappet element
8 Protruding region of the tie rod and/or push rod
9 Locking element of the charging, fueling, or service cover
10 Bearing for the tie rod and/or push rod
11 Discharge element
12 Region of the charging, fueling, or service cover for the discharge element
13 Drive gearwheel
14 Pivot axis of the pivoting mechanism for the charging, fueling, or service cover
15 Drive wheel
16 Rotary body of the flap lock/restraint
17 First lever arm region of the rotary body
18 Second lever arm region of the rotary body
19 Third lever arm region of the rotary body
20 Fourth lever arm region of the rotary body
21 Tie element and/or push element
22 Freewheel
23 Pin element
24 Restraint

What is claimed is:

1. An actuating mechanism (1) for actuating a charging, fueling, or service cover (2) on a charging, fueling, or service compartment (3) configured to be received on or in a body component of a vehicle, wherein the charging, fueling, or service flap (2) is pivotable between a closed position and an open position relative to the charging, fueling, or service compartment (3), the actuating mechanism (1) comprising:
a drive comprising an electric motor and configured to drive a drive shaft (4); and
a drive mechanism coupled with the drive and configured to tap a rotational movement of the drive shaft (4) when the drive is actuated and to convert the rotational movement into a first movement for manipulating a locking element (5) of a flap lock/restraint and into a second movement for pivoting the charging, fueling, or service cover (2),
wherein the locking element (5) is mounted pivotably about an axis of rotation relative to the charging, fueling, or service compartment (3) and configured to move between a locked position and an unlocked position,
wherein the drive mechanism comprises a tie rod and/or push rod (6) for to manipulate the locking element (5),
wherein the tie rod and/or push rod (6) is coupled to the locking element (5) via an end region of the tie rod and/or push rod (6) facing the locking element (5), and
wherein the tie rod and/or push rod (6) is operatively connected to, or can be brought into operative connection with, the drive shaft (4) via a releasable engagement.

2. The actuating mechanism (1) according to claim 1,
wherein the drive mechanism associated with the drive comprises a protrusion operatively connected to the drive shaft (4) and serving as a tappet element (7), which is configured for releasable engagement with a protruding region (8) of the tie rod and/or push rod (6), so that, when the drive shaft (4) is rotated in a first direction of rotation and about a first rotational angular range, the protrusion of the drive shaft (4) serving as the tappet element (7) pulls the tie rod and/or push rod (6) in a direction away from the locking element (5) or slides it in a direction towards the locking element (5), at least by a predefined distance.

3. The actuating mechanism (1) according to claim 2,
wherein the predefined distance, by which the tie rod and/or push rod (6) is configure to move upon a rotation of the drive shaft (4) in the first direction of rotation and about the first rotational angular range with the protrusion of the drive shaft (4) serving as the tappet element (7), is selected such that the locking element (5) is pivoted from its locked position into its unlocked position.

4. The actuating mechanism (1) according to claim 2,
wherein the protrusion of the drive shaft (4) serving as the tappet element (7) is configured such that, when the drive shaft (4) is further rotated beyond the first rotational angular range, the engagement between the protrusion of the drive shaft (4) serving as the tappet element (7) and the protruding region (8) of the tie rod and/or push rod (6) is released.

5. The actuating mechanism (1) according to claim 2,
wherein the releasable engagement between the protrusion of the drive shaft (4) serving as the tappet element (7) and the protruding region (8) of the tie rod and/or push rod (6) is selected such that, even without a rotation of the drive shaft (4) in the first direction of rotation, the tie rod and/or push rod (6) can be moved in the direction away from the locking element (5) or in the direction towards the locking element (5) in a situation in which the locking element (5) is pivoted from its locked position into its unlocked position via a manually actuatable emergency release.

6. The actuating mechanism (1) according to claim 2,
wherein the protrusion of the drive shaft (4) serving as the tappet element (7) and/or the protruding region (8) of the tie rod and/or push rod (6) is configured elastically in such a way that, even without a rotation of the drive shaft (4) in the first direction of rotation, the tie rod and/or push rod (6) can be moved in the direction away from the locking element (5) or in the direction towards the locking element (5) in a situation in which the locking element (5) is pivoted from its locked position into its unlocked position via a manually actuatable emergency release.

7. The actuating mechanism (1) according to claim 1,
wherein a spring is associated with the locking element (5) and biases the locking element (5) into its locked position.

8. The actuating mechanism (1) according to claim 7,
wherein the tie rod and/or push rod (6) is at least regionally flexible or spring-elastic, or comprises a flexibly or spring-elastically configured region, such that the charging, fueling, or service cover (2) is manually transferable from its open position into its closed position and, in doing so, the locking element (5) is manually transferable from its spring-biased locked position into its unlocked position.

9. The actuating mechanism (1) according to claim 1,
wherein the locking element (5) is configured to engage in its locked position with a locking element (5) of the charging, fueling, or service cover (2) when the charging, fueling, or service cover (2) is in its closed position.

10. The actuating mechanism (1) according to claim 1,
wherein the tie rod and/or push rod (6) is associated with a bearing (10) in the form of a radial sliding bearing for guiding a movement of the tie rod and/or push rod (6) relative to the charging, fueling, or service compartment (3).

11. The actuating mechanism (1) according to claim 1,
wherein the flap lock/restraint comprises a discharge element (11) configured as a protrusion, which, together with the locking element (5), is borne to be pivotable about the axis of rotation of the locking element (5) relative to the charging, fueling, or service compartment (3) between a countersunk first position and an exposed second position,
wherein the discharge element (11) is in its first countersunk position when the locking element (5) is in its locked position,
wherein the discharge element (11) is transferred into its second exposed position when the locking element (5) is transferred into its unlocked position, and
wherein the discharge element (11) is configured such that, when the discharge element (11) is transferred into its second exposed position, the discharge element (11) strikes against a region (12) of the charging, fueling, or service cover (2) that is provided on the inner side of the charging, fueling, or service cover (2), thus moving the latter from its closed position towards its open position.

12. The actuating mechanism (1) according to claim 1,
wherein the drive mechanism associated with the drive comprises a drive wheel, which is operatively connected to the drive shaft (4) and is at least partially or regionally configured as a drive gearwheel (13) having a front toothing,
wherein, for pivoting the charging, fueling, or service cover (2) relative to the charging, fueling, or service compartment (3), the charging, fueling, or service cover (2) is associated with a pivoting mechanism, which comprises a shaft that extends along a pivot axis (14) of the charging, fueling, or service cover (2) with a drive wheel (15) operatively connected thereto, which is configured at least partially or regionally as a gearwheel having a toothing, and
wherein, in the case of a transfer of the charging, fueling, or service cover (2) from its closed position into its open position, and vice versa, caused by means of the drive, the toothing of the drive gearwheel (13), which is configured as a front toothing, is engaged with the toothing of the drive wheel (15), which is configured as a front toothing, of the pivoting mechanism associated with the charging, fueling, or service cover (2).

13. The actuating mechanism (1) according to claim 12,
wherein the toothing of the drive gearwheel (13), which is configured as a front toothing, and the toothing of the drive wheel (15) of the pivoting mechanism associated with the charging, fueling, or service cover (2), which is configured as a front toothing, are configured to engage with one another only when the protrusion of the drive shaft (4) serving as the tappet element (7) is rotated about the first rotational angular range.

14. The actuating mechanism (1) according to claim 12,
wherein the toothing of the drive gearwheel (13) and the toothing of the drive wheel (15) of the pivoting mechanism associated with the charging, fueling, or service cover (2) are configured such that, in the closed position of the charging, fueling, or service cover (2), a rotation of the drive wheel of the pivoting mechanism associated with the charging, fueling, or service cover (2) is not blocked by the drive gearwheel (13), so that, even without activation of the drive, the charging, fueling, or service cover (2) is manually transferable from its closed position into its open position in a situation after the locking element (5) has been pivoted from its locked position into its unlocked position via a preferably manually actuatable emergency release.

15. The actuating mechanism (1) according to claim 11, wherein the flap lock/restraint comprises a rotary body (16), which is mounted pivotably about the axis of rotation of the locking element (5) relative to the charging, fueling, or service compartment (3), having a first lever arm region (17), which at least partially or regionally forms the locking element (5), a second lever arm region (18), which at least partially or regionally forms the discharge element (11), and a third lever arm region (19), to which the end region of the tie rod and/or push rod (6) facing the locking element (5) is connected in an articulated manner.

16. The actuating mechanism (1) according to claim 15,
wherein the rotary body (16) of the flap lock/restraint further comprises a fourth lever arm region (20), to which a tie element (21) of a manually actuatable emergency release is connected in an articulated manner in such a way that, upon actuation of the emergency release, the rotary body (16) with its lever arm regions (17, 18, 19, 20) is rotatable about the axis of rotation of the locking element (5).

17. The actuating mechanism (1) according to claim 16,
wherein the tie element (21) of the manually actuatable emergency release comprises a freewheel (22), which is configured such that a rotation of the rotary body (16) of the flap lock/restraint about the axis of rotation of the locking element (5) is possible without introducing a force component into the tie element (21) of the emergency release via the fourth lever arm region (20) of the rotary body (16), which would cause a movement of the tie element (21) of the emergency release relative to the rotary body (16) of the flap lock/restraint.

18. The actuating mechanism (1) according to claim 17,
wherein the freewheel (22) comprises an elongated hole guide, which is configured in the tie element (21) of the emergency release, into which a pin element (23) or sliding block of the fourth lever arm region engages.

19. The actuating mechanism (1) according to claim 18,
wherein, by pulling the tie element (21) of the emergency release, the tie element (21) can be moved by a distance relative to the rotary body (16) of the flap lock/restraint, said distance being defined by the elongated hole guide configured in the tie element (21) of the emergency release, without introducing a tensile force component from the tie element (21) of the emergency release into the rotary body (16) of the flap lock/restraint,
wherein, by contrast, after overcoming the distance defined by the elongated hole guide configured in the tie element (21) of the emergency release, a tensile force component introduced into the tie element (21) of the emergency release is introduced directly into the rotary body (16) of the flap lock/restraint.

20. The actuating mechanism (1) according to claim 19,
wherein a locking mechanism (24) is associated with the tie element (21) of the emergency release for releasably restraining the tie element (21) in a position of the tie element (21) after the distance defined by the elongated hole guide configured in the tie element (21) of the emergency release has been overcome.
